(19) United States
(12) Patent Application Publication
(10) Pub. No.: US 2008/0230485 A1
(43) Pub. Date: Sep. 25, 2008

(54) Method and Apparatus For Wastewater Treatment

(76) Inventors: Ronen Itzhak Shechter, Tivon (IL); Eytan Baruch Levy, Ila'Ein (IL); Nir Moralechai Assulin, Hibat Zion (IL)

Correspondence Address: KNOBBE MARTENS OLSON & BEAR LLP, 2040 MAIN STREET, FOURTEENTH FLOOR, IRVINE, CA, 92614, US

(21) Appl. No.: 12/065,602

(22) PCT Filed: Sep. 7, 2006
(86) PCT No.: PCT/IL06/01045

§ 371 Date: Apr. 18, 2008

Related U.S. Application Data
(60) Provisional application No. 60/715,019, filed on Sep. 7, 2005.

(51) Int. Cl. C02F 1/20; C02F 9/02; B01D 15/18; C02F 9/04

(52) U.S. Cl. 210/750; 210/767; 210/773; 210/801; 210/259; 210/202; 210/201; 210/195.1; 210/258

(57) ABSTRACT

A method for removal of foam from at least one foam accumulation region in a wastewater treatment facility, the method including causing the foam to flow from the at least one foam accumulation region into at least one foam collector and removing the foam from the at least one foam collector.

### REFERENCE TO RELATED APPLICATIONS

The present application is related to U.S. Provisional Patent Application Ser. No. 60/715,019 filed Sep. 7, 2005, and entitled METHOD AND APPARATUS FOR WASTEWATER TREATMENT, the disclosure of which is hereby incorporated by reference and priority of which is hereby claimed pursuant to 37 CFR 1.78(a)(4) and (5)(i).

### FIELD OF THE INVENTION

The present invention relates to treatment of wastewater generally and more particularly to treatment of foam in wastewater.

### BACKGROUND OF THE INVENTION

The following published documents are believed to represent the current state of the art and the contents thereof are hereby incorporated by reference:

U.S. Pat. Nos. 4,310,437; 4,373,024; 4,5078,546; 4,960,540; 5,108,655; 5,783,089; 5,827,453; 5,928,493; 6,207,722; 6,534,550; 6,616,845; 6,660,164; 6,689,271; 6,726,838; 6,960,304; 6,962,653 and 7,001,519;

U.S. Published Patent Application Nos.: 2003/0087969 and 2004/0089592;

“Biological treatment of highly foaming pharmaceutical wastewater by modified bubble-column under mechanical foam control”, K. Yamagiwa, M. Yoshida, A. Ohikawa and S. Takesono, Water Science & Technology, Vol 42 No 3-4, pp 331-337, IWA Publishing 2000;

“Performance characteristics of mechanical foam-breakers fitted to a stirred-tank reactor”, Takesono S., Onodera M., Yoshida M., Yamagiwa K., Ohkawa A., Journal of Chemical Technology & Biotechnology, Volume 78, Number 1, January 2003, pp. 48-55(8);

“Aeration: Principles and Practice”, James A Mueller, William C. Boyle and H. Johannes Popel, CRC Press, 2002, ISBN 1-56676-948-5, pp. 64-70; and

“Aeration—A Wastewater Treatment Process”, WEF—Manual of Practice No. FD-13, ASCE—Manuals and Reports on Engineering Practice No. 68, 1988, ISBN 0-87262-673-3, p. 51.

### SUMMARY OF THE INVENTION

The present invention seeks to provide a system and a method for treatment of foam in wastewater.

There is thus provided in accordance with a preferred embodiment of the present invention a method for removal of foam from at least one foam accumulation region in a wastewater treatment facility, the method including causing the foam to flow from the at least one foam accumulation region into at least one foam collector and removing the foam from the at least one foam collector.

In accordance with a preferred embodiment of the present invention the method also includes causing the foam in the at least one foam collector to at least partially collapse into a liquid and wherein the removing the foam includes removing the liquid. Preferably, the wastewater treatment facility includes an aeration tank and the at least one foam accumulation region is defined by at least one roll pattern of aerated wastewater produced by aeration of wastewater in the aeration tank. Additionally, the removing the foam includes removing the foam to a location outside of the aeration tank.

In accordance with another preferred embodiment of the present invention, when aeration is not taking place in the aeration tank, the wastewater generally fills the aeration tank to a still-water level and when aeration takes place, the wastewater reaches an aerated water level a few centimeters above the still-water level and wherein the at least one foam collector defines at least one edge lying between the still-water level and the aerated water level, the foam overflowing the at least one edge and passing into the at least one foam collector.

In accordance with yet another preferred embodiment of the present invention the at least one foam collector is a foam collection conduit. Preferably, the causing the foam to at least partially collapse includes foam collapse enhancing spraying onto the foam. Additionally or alternatively, the spraying includes spraying at least one of an anti-foaming agent, treated wastewater, re-circulated collapsed foam and air.

In accordance with a further preferred embodiment of the present invention the removing includes removing the foam from the at least one foam collector by gravity. Alternatively, the removing includes pumping the foam from the at least one foam collector. Preferably, the pumping includes employing an airlift pump.

There is also provided in accordance with another preferred embodiment of the present invention a system for removal of foam from at least one foam accumulation region in a liquid processing facility, the system including at least one foam collector located at the at least one foam accumulation region for receiving the foam and a foam remover, removing the foam from the at least one foam collector.

In accordance with a preferred embodiment of the present invention the system also includes at least one foam collapse enhancer, causing the foam in the at least one foam collector to at least partially collapse into a collapsed foam liquid and wherein the foam remover is operative to remove the collapsed foam liquid. Preferably, the system also includes an aeration tank and the at least one foam accumulation region is defined by at least one roll pattern of aerated liquid produced by aeration of liquid in the aeration tank. Additionally, the foam remover is operative to remove the collapsed foam liquid to a location outside of the aeration tank.

In accordance with another preferred embodiment of the present invention, when aeration is not taking place in the aeration tank, the liquid generally fills the aeration tank to a still-water level and when aeration takes place, the liquid reaches an aerated water level a few centimeters above the still-water level and the at least one foam collector defines at least one edge lying between the still-water level and the aerated water level, the foam overflowing the at least one edge and passing into the at least one foam collector.

In accordance with yet another preferred embodiment of the present invention the at least one foam collector includes at least one foam collection conduit. Preferably, the system also includes spray nozzles operative to provide foam collapse enhancing spraying onto the foam. Additionally, the spray nozzles are operative to spray at least one of an anti-foaming agent, treated wastewater, re-circulated collapsed foam and air.

In accordance with a further preferred embodiment of the present invention the foam remover is operative to remove the foam from the at least one foam collector by gravity. Alternatively, the foam remover includes a pump operative to pump the foam from the at least one foam collector. Preferably, the pump includes an airlift pump.

In accordance with yet a further preferred embodiment of the present invention the system also includes a liquid processing facility. Preferably, the liquid processing facility includes a wastewater treatment facility. Additionally, the wastewater treatment facility includes at least one solid/liquid separator operative to receive wastewater following removal of the foam therefrom. As a further addition, the liquid includes wastewater.

### BRIEF DESCRIPTION OF THE DRAWINGS

The present invention will be understood and appreciated more fully from the following detailed description, taken in conjunction with the drawings in which:

FIGS. 1A and 1B are simplified pictorial and sectional illustrations of a wastewater treatment system including functionality for removal of foam from wastewater, constructed and operative in accordance with a preferred embodiment of the present invention, the sectional illustration being taken along section lines IB-IB in FIG. 1A;

FIGS. 2A and 2B are simplified pictorial and sectional illustrations of a wastewater treatment system including functionality for removal of foam from wastewater, constructed and operative in accordance with another preferred embodiment of the present invention, the sectional illustration being taken along section lines IIB-IIB in FIG. 2A; and

FIGS. 3A and 3B are simplified pictorial and sectional illustrations of a wastewater treatment system including functionality for removal of foam from wastewater, constructed and operative in accordance with yet another preferred embodiment of the present invention, the sectional illustration being taken along section lines IIIB-IIIB in FIG. 3A.

### DETAILED DESCRIPTION OF PREFERRED EMBODIMENTS

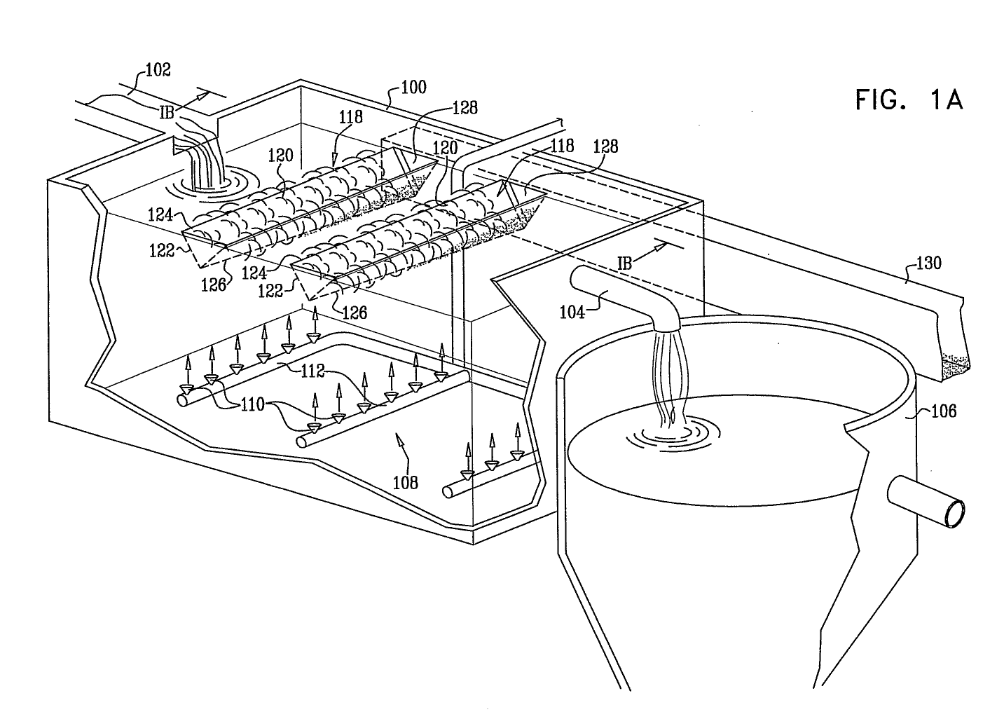

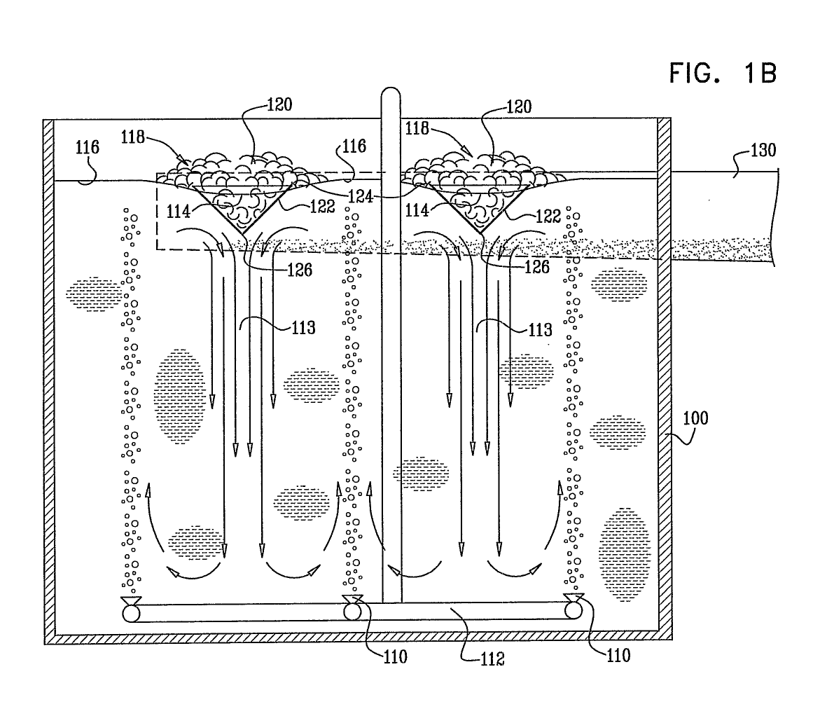

Reference is now made to FIGS. 1A and 1B, which are simplified pictorial and sectional illustrations of a wastewater treatment system including functionality for removal of foam from wastewater, constructed and operative in accordance with a preferred embodiment of the present invention.

FIGS. 1A and 1B illustrate a system for removal of foam from at least one foam accumulation region in a liquid processing facility, the system including at least one foam collector located at the at least one foam accumulation region for receiving the foam and a foam remover, removing the foam from the at least one foam collector.

As seen in FIGS. 1A and 1B, the wastewater treatment system typically comprises an aeration tank 100 which receives wastewater at an inlet 102 and supplies aerated wastewater at an outlet 104. The aerated wastewater is typically supplied to a solid/liquid separator 106. The aeration tank 100 may also contain active biomass or other biological treatment agents for providing biological treatment of the wastewater during aeration thereof.

Aeration tank 100 typically includes an aeration and/or agitation subsystem 108, such as that described in assignee's U.S. Pat. Nos. 6,616,845 and 6,726,838, the disclosure of which is hereby incorporated by reference. Any other suitable aeration and/or agitation apparatus may be employed. The aeration and/or agitation subsystem 108, as seen in FIGS. 1A and 1B, typically includes a multiplicity of air supply nozzles 110 arranged along air supply conduits 112 which receive air under pressure from a pressurized air source (not shown). The air supply nozzles 110 are preferably arranged in mutually spaced rows so as to create mutually spaced roll patterns of airlifted water, designated by reference numeral 113.

When aeration is not taking place therein, wastewater generally fills the aeration tank 100 to a still-water level indicated by reference numeral 114. When aeration takes place, the water level of the wastewater overlying the nozzles 110 in the roll patterns 113 rises a few centimeters above the still-water level 114 to an aerated water level 116. The differences in water level between the still-water level 114 and the aerated water level 116 result from the airlift produced by aeration.

Depending on the arrangement of the nozzles 110, foam accumulation regions 118 are defined at locations where the level of the wastewater lies approximately at still-water level 114, slightly below aerated water level 116. In normal operation of a wastewater treatment system, substantial quantities of foam 120 accumulate at the foam accumulation regions 118.

In accordance with a preferred embodiment of the present invention, foam collectors, preferably in the form of foam collection conduits 122, are placed at foam accumulation regions 118. The foam collection conduits 122 may extend along the entire length of a given foam accumulation region 118 or may extend along only part of a given foam accumulation region 118. The foam collection conduits 122 may have any suitable cross-sectional configuration, such as a triangular, hemispherical or rectangular cross-sectional configuration. Top edges 124 of the foam collection conduits 122 may be straight, notched, perforated or configured in any suitable manner.

Foam collection conduits 122 are preferably placed in the tank 100 such that the top edges 124 thereof lie slightly above the still-water level 114 and preferably slightly below aerated water level 116. In accordance with an embodiment of the present invention, foam 120 in the foam accumulation regions 118 overflows top edges 124 into the foam collection conduits 122, and at least partially collapses into a liquid, as the result of shear stress encountered in overflowing edges 124.

Bottom portions 126 of the foam collection conduits 122 are preferably downwardly sloped toward disposal outlets 128 which are in fluid flow communication with one or more disposal conduits 130, typically located outside tank 100. The foam and liquid accumulated in the foam collection conduits 122 leave tank 100 via disposal outlets 128 and disposal conduits 130, and preferably flows therealong under the force of gravity.

It is a particular feature of the present invention that at least part of the foaming agents contained in the wastewater in tank 100, which are typically present in the foam 120, are removed from tank 100 together with the liquid collected in foam collection conduits 122.

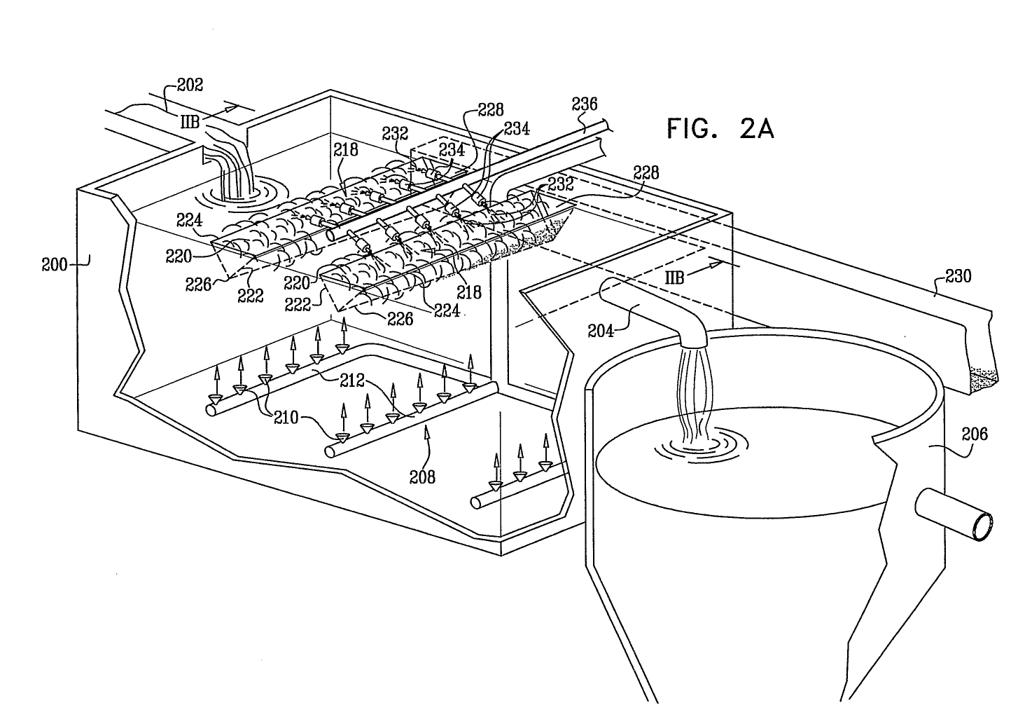

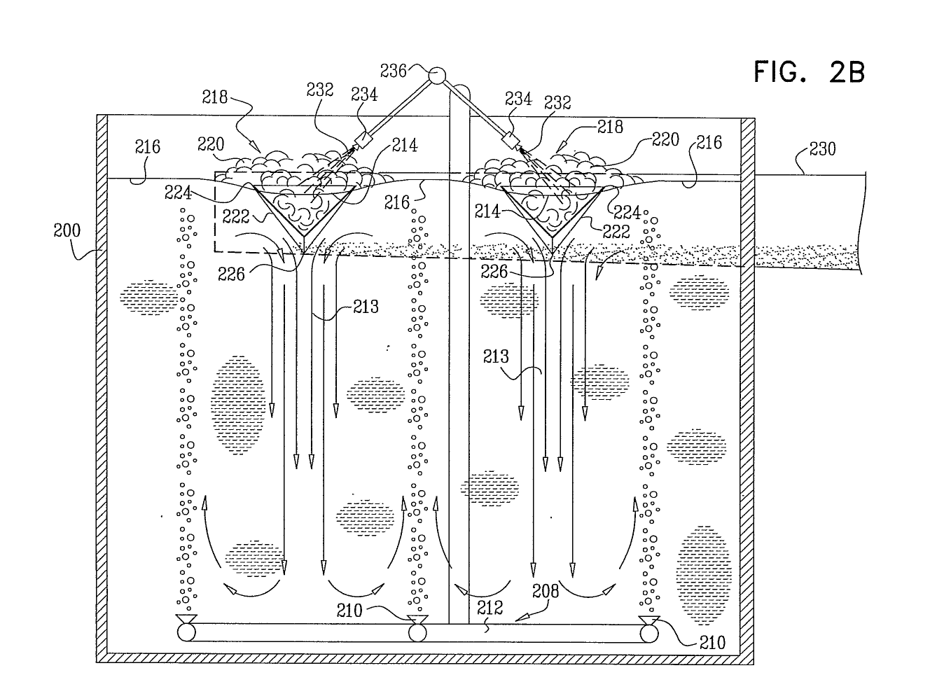

Reference is now made to FIGS. 2A and 2B, which are simplified pictorial and sectional illustrations of a wastewater treatment system including functionality for removal of foam from wastewater, constructed and operative in accordance with another preferred embodiment of the present invention.

As seen in FIGS. 2A and 2B, the wastewater treatment system typically comprises an aeration tank 200 which receives wastewater at an inlet 202 and supplies aerated wastewater at an outlet 204. The aerated wastewater is typically supplied to a solid/liquid separator 206. The aeration tank 200 may also contain active biomass or other biological treatment agents for providing biological treatment of the wastewater during aeration thereof.

Aeration tank 200 typically includes an aeration and/or agitation subsystem 208, such as that described in assignee's U.S. Pat. Nos. 6,616,845 and 6,726,838, the disclosure of which is hereby incorporated by reference. Any other suitable aeration and/or agitation apparatus may be employed. The aeration and/or agitation subsystem 208, as seen in FIGS. 2A and 2B, typically includes a multiplicity of air supply nozzles 210 arranged along air supply conduits 212 which receive air under pressure from a pressurized air source (not shown). The air supply nozzles 210 are preferably arranged in mutually spaced rows so as to create mutually spaced roll patterns of airlifted water, designated by reference numeral 213.

When aeration is not taking place therein, wastewater generally fills the aeration tank 200 to a still-water level indicated by reference numeral 214. When aeration takes place, the water level of the wastewater overlying the nozzles 210 in the roll patterns 213 rises a few centimeters above the still-water level 214 to an aerated water level 216. The differences in water level between the still-water level 214 and the aerated water level 216 result from the airlift produced by aeration.

Depending on the arrangement of the nozzles 210, foam accumulation regions 218 are defined at locations where the level of the wastewater lies approximately at still-water level 214, slightly below aerated water level 216. In normal operation of a wastewater treatment system, substantial quantities of foam 220 accumulate at the foam accumulation regions 218.

In accordance with a preferred embodiment of the present invention, foam collectors, preferably in the form of foam collection conduits 222, are placed at foam accumulation regions 218. The foam collection conduits 222 may extend along the entire length of a given foam accumulation region 218 or may extend along only part of a given foam accumulation region 218. The foam collection conduits 222 may have any Suitable cross-sectional configuration, such as a triangular, hemispherical or rectangular cross-sectional configuration. Top edges 224 of the foam collection conduits 222 may be straight, notched, perforated or configured in any suitable manner.

Foam collection conduits 222 are preferably placed in the tank 200 such that the top edges 224 thereof lie slightly above the still-water level 214 and preferably slightly below aerated water level 216. In accordance with an embodiment of the present invention, foam 220 in the foam accumulation regions 218 overflows top edges 224 into the foam collection conduits 222, and at least partially collapses into a liquid, as the result of shear stress encountered in overflowing edges 224.

Bottom portions 226 of the foam collection conduits 222 are preferably downwardly sloped toward disposal outlets 228 which are in fluid flow communication with one or more disposal conduits 230, typically located outside tank 200. The foam and liquid accumulated in the foam collection conduits 222 leave tank 200 via disposal outlets 228 and disposal conduits 230, and preferably flows therealong under the force of gravity.

In the illustrated embodiment of FIGS. 2A and 2B, a pressurized spray of foam collapse enhancing material 232 is supplied to the foam 220 in foam collection conduits 222 by a multiplicity of nozzles 234, which are supplied with the foam collapse enhancing material 232 by pressurized supply conduits 236 coupled to a source of foam collapse enhancing material (not shown). Foam collapse enhancing material 232 may comprise any suitable material, such as treated wastewater, recirculated collapsed foam, chemical anti-foaming agents, air or any suitable combination thereof.

It is a particular feature of the present invention that at least part of the foaming agents contained in the wastewater in tank 200, which are typically present in the foam 220, are removed from tank 200 together with the liquid collected in foam collection conduits 222.

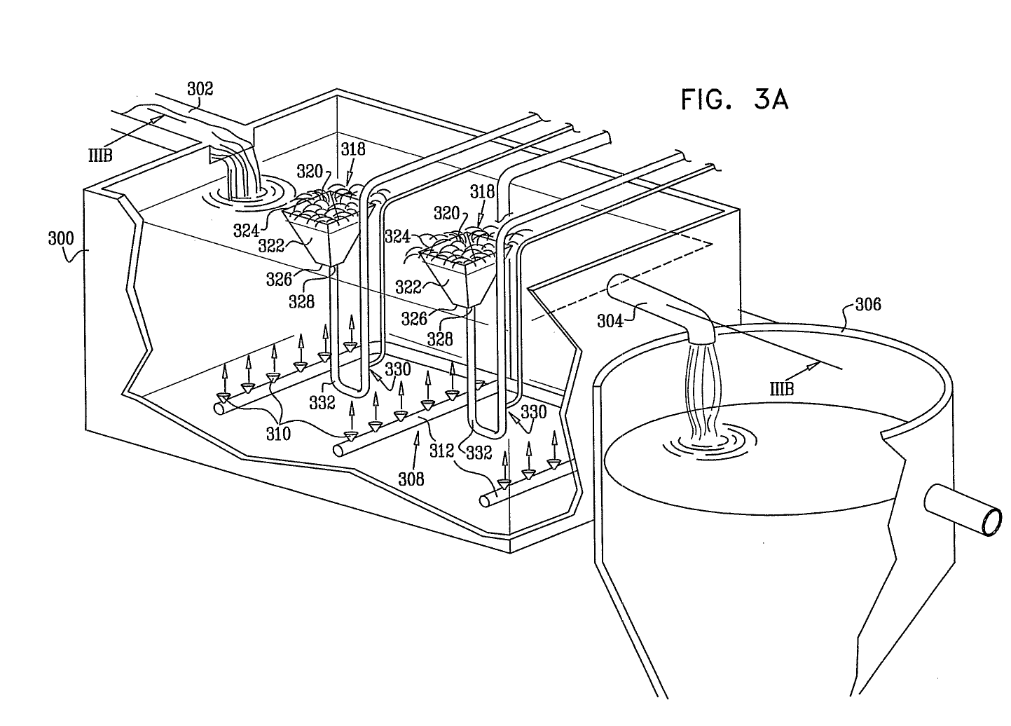

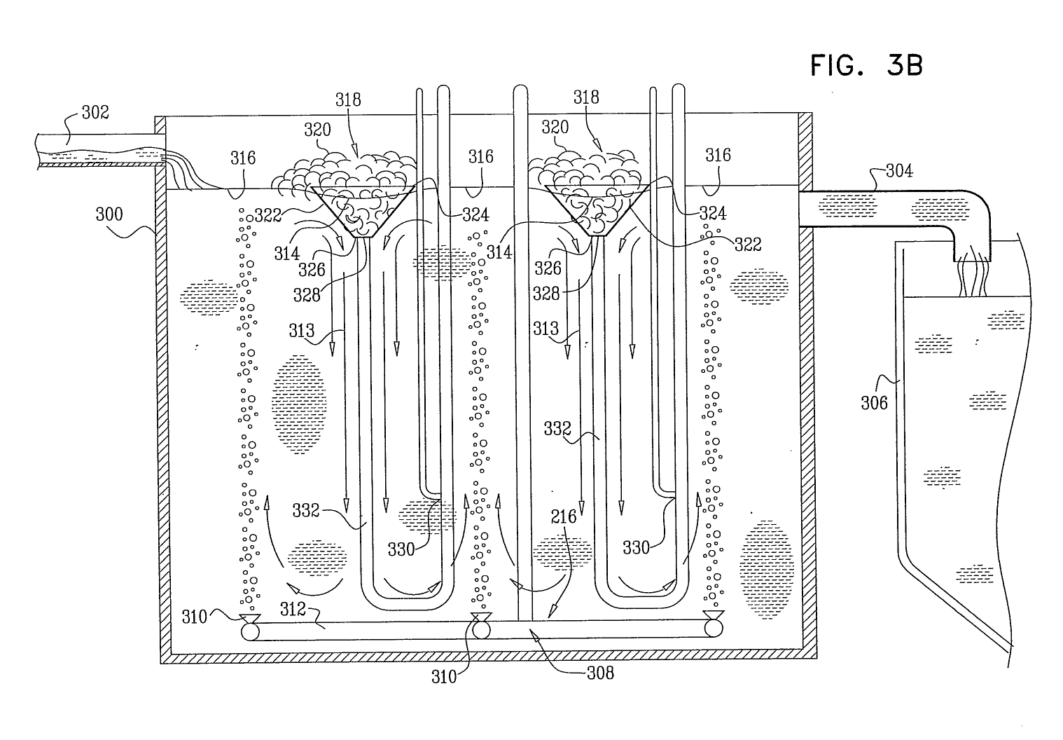

Reference is now made to FIGS. 3A and 3B, which are simplified pictorial and sectional illustrations of a wastewater treatment system including functionality for removal of foam from wastewater, constructed and operative in accordance with yet another preferred embodiment of the present invention.

As seen in FIGS. 3A and 3B, the wastewater treatment system typically comprises an aeration tank 300 which receives wastewater at an inlet 302 and supplies aerated wastewater at an outlet 304. The aerated wastewater is typically supplied to a solid/liquid separator 306. The aeration tank 300 may also contain active biomass or other biological treatment agents for providing biological treatment of the wastewater during aeration thereof.

Aeration tank 300 typically includes an aeration and/or agitation subsystem 308, such as that described in assignee's U.S. Pat. Nos. 6,616,845 and 6,726,838, the disclosure of which is hereby incorporated by reference. Any other suitable aeration and/or agitation apparatus may be employed. The aeration and/or agitation subsystem 308, as seen in FIGS. 3A and 3B, typically includes a multiplicity of air supply nozzles 310 arranged along air supply conduits 312 which receive air under pressure from a pressurized air source (not shown). The air supply nozzles 310 are preferably arranged in mutually spaced rows so as to create mutually spaced roll patterns of airlifted water, designated by reference numeral 313.

When aeration is not taking place therein, wastewater generally fills the aeration tank 300 to a still-water level indicated by reference numeral 314. When aeration takes place, the water level of the wastewater overlying the nozzles 310 in the roll patterns 313 rises a few centimeters above the still-water level 314 to an aerated water level 316. The differences in water level between the still-water level 314 and the aerated water level 316 result from the airlift produced by aeration.

Depending on the arrangement of the nozzles 310, foam accumulation regions 318 are defined at locations where the level of the wastewater lies approximately at still-water level 314, slightly below aerated water level 316. In normal operation of a wastewater treatment system, substantial quantities of foam 320 accumulate at the foam accumulation regions 318.

In accordance with a preferred embodiment of the present invention, foam collectors, preferably in the form of foam collection conduits 322, are placed at foam accumulation regions 318. The foam collection conduits 322 may extend along the entire length of a given foam accumulation region 318 or may extend along only part of a given foam accumulation region 318. The foam collection conduits 322 may have any suitable cross-sectional configuration, such as a triangular, hemispherical or rectangular cross-sectional configuration. Top edges 324 of the foam collection conduits 322 may be straight, notched, perforated or configured in any suitable manner.

Foam collection conduits 322 are preferably placed in the tank 300 such that the top edges 324 thereof lie slightly above the still-water level 314 and preferably slightly below level 316. In accordance with an embodiment of the present invention, foam 320 in the foam accumulation regions 318 overflows top edges 324 into the foam collection conduits 322, and at least partially collapses into a liquid, as the result of shear stress encountered in overflowing edges 324.

Bottom portions 326 of the foam collection conduits 322 are preferably downwardly sloped toward disposal outlets 328. The foam and liquid accumulated in the foam collection conduits 322 is preferably pumped from disposal outlets 328 by a pump 330, such as an airlift pump or any other suitable pump, via disposal conduits 332 to a collection container (not shown).

It is a particular feature of the present invention that at least part of the foaming agents contained in the wastewater in tank 300, which are typically present in the foam 320, are removed from tank 300 together with the liquid collected in foam collection conduits 322.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A method for removal of foam from at least one foam accumulation region in a wastewater treatment facility, the method comprising:
causing said foam to flow from said at least one foam accumulation region into at least one foam collector; and
removing said foam from said at least one foam collector.

2. A method according to claim 1 and also comprising causing said foam in said at least one foam collector to at least partially collapse into a liquid and wherein said removing said foam includes removing said liquid.

3. A method according to claim 1 wherein said wastewater treatment facility comprises an aeration tank and said at least one foam accumulation region is defined by at least one roll pattern of aerated wastewater produced by aeration of wastewater in said aeration tank.

4. A method according to claim 3 and wherein said removing said foam comprises removing said foam to a location outside of said aeration tank.

5. A method according to claim 3 and wherein when aeration is not taking place in said aeration tank, said wastewater generally fills said aeration tank to a still-water level and when aeration takes place, said wastewater reaches an aerated water level a few centimeters above said still-water level and wherein said at least one foam collector defines at least one edge lying between said still-water level and said aerated water level, said foam overflowing said at least one edge and passing into said at least one foam collector.

6. A method according to claim 2 and wherein said at least one foam collector is a foam collection conduit.

7. A method according to claim 2 and wherein said causing said foam to at least partially collapse comprises foam collapse enhancing spraying onto said foam.

8. A method according to claim 7 and wherein said spraying comprises spraying at least one of an anti-foaming agent, treated wastewater, re-circulated collapsed foam and air.

9. A method according to claim 1 and wherein said removing comprises removing said foam from said at least one foam collector by gravity.

10. A method according to claim 1 and wherein said removing comprises pumping said foam from said at least one foam collector.

11. A method according to claim 10 and wherein said pumping comprises employing an airlift pump.

12. A system for removal of foam from at least one foam accumulation region in a liquid processing facility, the system comprising:
at least one foam collector located at said at least one foam accumulation region for receiving said foam; and
a foam remover, removing said foam from said at least one foam collector.

13. A system according to claim 12 and also comprising at least one foam collapse enhancer, causing said foam in said at least one foam collector to at least partially collapse into a collapsed foam liquid and wherein said foam remover is operative to remove said collapsed foam liquid.

14. A system according to claim 12 and also comprising an aeration tank and wherein said at least one foam accumulation region is defined by at least one roll pattern of aerated liquid produced by aeration of liquid in said aeration tank.

15. A system according to claim 14 and wherein said foam remover is operative to remove said collapsed foam liquid to a location outside of said aeration tank.

16. A system according to claim 14 and wherein when aeration is not taking place in said aeration tank, said liquid generally fills said aeration tank to a still-water level and when aeration takes place, said liquid reaches an aerated water level a few centimeters above said still-water level and wherein said at least one foam collector defines at least one edge lying between said still-water level and said aerated water level, said foam overflowing said at least one edge and passing into said at least one foam collector.

17. A system according to claim 12 and wherein said at least one foam collector comprises at least one foam collection conduit.

18. A system according to claim 12 and also comprising spray nozzles operative to provide foam collapse enhancing spraying onto said foam.

19. A system according to claim 18 and wherein said spray nozzles are operative to spray at least one of an anti-foaming agent, treated wastewater, re-circulated collapsed foam and air.

20. A system according to claim 12 and wherein said foam remover is operative to remove said foam from said at least one foam collector by gravity.

21. A system according to claim 12 and wherein said foam remover comprises a pump operative to pump said foam from said at least one foam collector.

22. A method according to claim 21 and wherein said pump comprises an airlift pump.

23. A system according to claim 12 and also comprising a liquid processing facility.

24. A system according to claim 23 and wherein said liquid processing facility comprises a wastewater treatment facility.

25. A system according to claim 24 and wherein said wastewater treatment facility comprises at least one solid/liquid separator operative to receive wastewater following removal of said foam therefrom.

26. A system according to claim 14 and wherein said liquid comprises wastewater.
